(19) United States
(12) Patent Application Publication
(10) Pub. No.: US 2008/0084359 A1
(43) Pub. Date: Apr. 10, 2008

(54) Method and apparatus to provide multiple monitor support using a single displayport connector

(75) Inventors: Joseph M. Giannuzzi, Cedar Park, TX (US); Subramanian Jayaram, Austin, TX (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: DELL PRODUCTS, LP, Round Rock, TX (US)

(21) Appl. No.: 11/543,574

(22) Filed: Oct. 5, 2006

(51) Int. Cl. G09G 5/00

(52) U.S. Cl. 345/1.1

(57) ABSTRACT

A video display controller for at least two DisplayPort-enabled display devices comprises a main link channel and an Extended Display Identification Data (EDID) manager. The main link channel is in communication with each of the display devices. The EDID manager accepts EDID data from the display devices and controls output to each of the display devices over a corresponding main link channel.

### FIELD OF THE DISCLOSURE

This invention relates generally to display devices for information handling systems, and relates more particularly to a method and apparatus to provide multiple monitor support using a single DisplayPort connector.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

An information handling system may include a display device such as a monitor, television, or projector. A video display controller used in an information handling system typically receives input from the central processing unit (CPU) and transmits a signal to the display device, which displays information to the user. Normally, an information handing system will include a display device connector that is designed to independently control only a single display device. Single display device connectors include a Digital Visual Interface-Integrated (DVI-I) connector, a DVI-Digital (DVI-D) connector, a DVI-Analog (DVI-A) connector, a 15-pin Video Graphics Adapter (VGA) connector, a 9-pin Monochrome Display Adapter/Computer Graphics Adapter/Enhanced Graphics Adapter (MDA/CGA/EGA) connector, an Apple Display Connector (ADC), an Apple Monitor Connector, and a Digital Flat Panel (DFP) connector. More recently, a proposal known as Display Port™ has been developed for display interfaces by the Video Electronics Standards Association.

Multiple display devices are useful to a user of an information handling device by allowing the user to view more information simultaneously. An example of a connector that was originally designed to independently control multiple display devices is offered by Molex, Inc. of Lislie, Ill. under the trademark “DMS-59.” If additional display devices are to be associated with the information handling system, each additional display device connector takes up additional space in the interior of the information handing system, and each additional display device consumes surface area on or near the exterior of the information handling system. A solution is shown in United States Patent Application Publication No. 2005/0162336, the disclosure of which is hereby incorporated by reference. In order to achieve a configuration with four display devices in a VGA or DVI environment, either a high cost custom card solution with four connectors and two core pieces of silicon and/or graphics processing units (GPUs) or a dual card arrangement is needed.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a schematic view of one embodiment of an apparatus to provide multiple monitor support in an information handling system; and

FIG. 2 is a schematic view of another embodiment of the apparatus.

The use of the same reference symbols in different drawings indicates similar or identical items.

### DETAILED DESCRIPTION

The following description in combination with the Figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

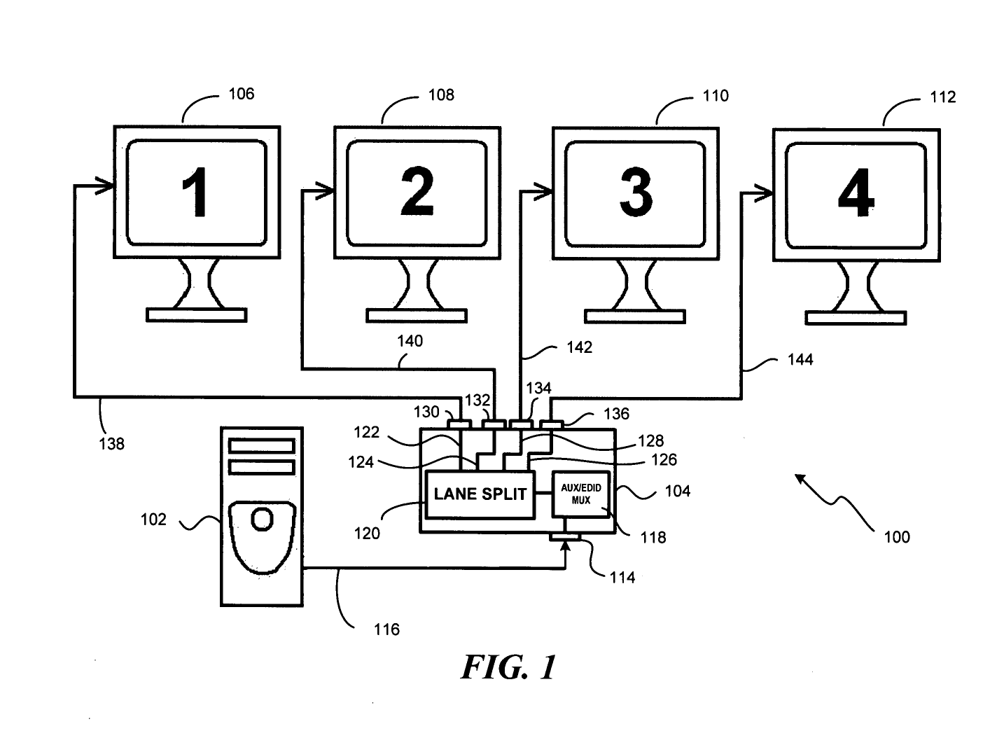

FIG. 1 shows an information handling system 100 including a personal computer 102, a video display controller 104, and display devices 106, 108, 110, and 112. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network server or storage device, a switch router or other network communication device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communications between the various hardware components.

The personal computer 102 preferably has an internal card with a GPU including logic and circuitry to control the settings of the display devices 106, 108, 110, and 112 and to receive configuration data from each of the display devices. The GPU is capable of independently controlling the resolution and refresh rate of the display devices. The internal card or some other output of the personal computer 102 has an electrical interface with the ability to drive a DisplayPort-enabled display with either one, two or four high speed wire pairs in addition to an auxiliary channel for Extended Display Identification Data (EDID) and audio transmissions. In particular, the auxiliary channel is used to establish control settings such as resolution and refresh rate with the display devices 106, 108, 110, and 112.

The video display controller 104 communicates between the personal computer 102 and the display devices 106, 108, 110, and 112. The video display controller 104 is preferably a multiplexing device external to the personal computer 102, and includes an input connector 114 for communicating over a line 116 with a digital-to-analog connector or DisplayPort transmit (DPTX) connector on the internal card in the personal computer 102. The video display controller 104 also has an auxiliary channel and/or EDID manager 118 and a lane splitter 120. The EDID manager 118 multiplexes the EDID/DDC channels by reading the EDID data from the multiple monitors in a serial fashion and combining it with an appropriate high speed wire pair such as main link (ML) 0 channel 122, ML1 channel 124, ML2 channel 126, or ML3 channel 128.

The lane splitter 120 communicates with display device connectors 130, 132, 134, and 136, which in turn respectively communicate with displays 106, 108, 110, and 112 through lines 138, 140, 142 and 144. The lane splitter 120 performs point-to-point separation of the four high speed pairs. It should be understood that while the EDID manager 118 and the lane splitter 120 are shown logically, their functions may be performed by a single processor. With this arrangement, one or more of the display devices 106, 108, 110 and 112 can normally be driven by a single high speed pair at a resolution in a range centered about 1280 by 1024 pixels at a refresh rate centered in a range of about 75 Hz. It should be appreciated that lower end (e.g., 6 and 8 bit) digital flat panel displays can be driven at higher resolution and/or refresh rates.

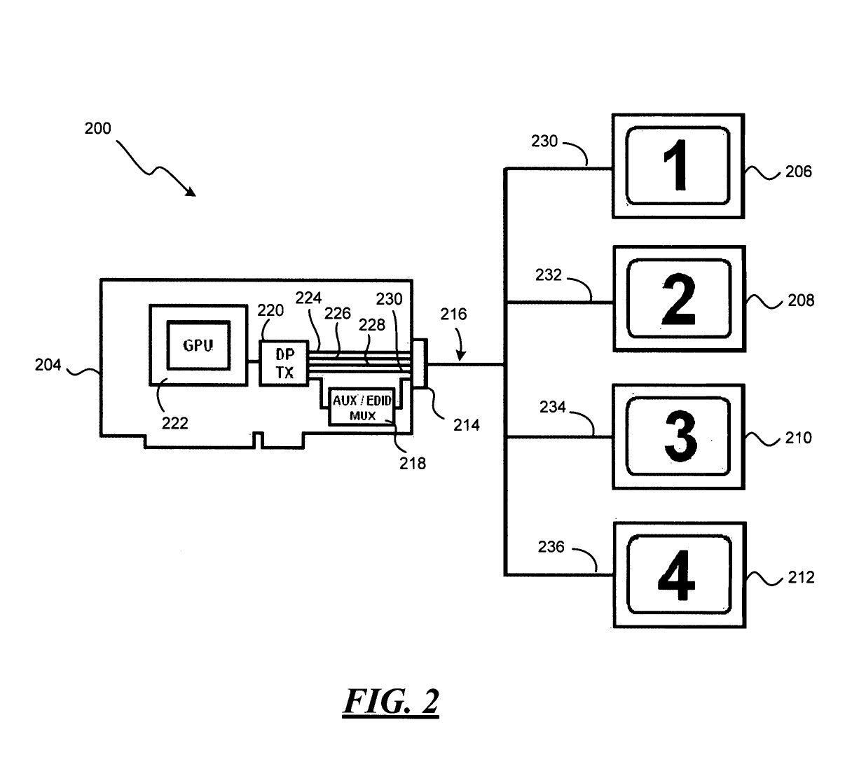

FIG. 2 shows another embodiment 200 of an information handling system including a personal computer graphics card 204 and display devices 206, 208, 210 and 212. The graphics card 204 communicates between the personal computer and the display devices, and includes a DisplayPort output connector 214 for communicating over a cable 216. The graphics card 204 also includes an auxiliary channel and EDID manager 218, a DPTX processor 220, and a GPU 222. As with the embodiment shown in FIG. 1, the auxiliary channel and EDID manager 218 multiplexes the EDID/DDC channels by serially reading the EDID data from the multiple monitors and then assigning an appropriate high speed pair such as main link (ML) 0 channel 224, ML1 channel 226, ML2 channel 228 or ML3 channel 229. The cable 216 includes branches 230, 232, 234 and 236 for respective communication with display devices 206, 208, 210 and 212. Because each of the ML channels 224, 226, 228 and 229 may be assigned to a corresponding branch 230, 232, 234 or 236, this cabling arrangement allows any combination of the display devices to be driven from the single output connector 214.

It should be noted that neither of the embodiments shown and described herein affects the functionality of the DisplayPort™ specification, such as the hot plug detect functionality. Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A video display controller for at least two DisplayPort-enabled display devices, the video display controller comprising:
a main link channel in communication with each of the display devices; and
an Extended Display Identification Data (EDID) manager accepting EDID data from the display devices and controlling output to each of the display devices over a corresponding main link channel.

2. The video display controller of claim 1, wherein the video display controller is external to a personal computer.

3. The video display controller of claim 2, further comprising a lane splitter in communication with the EDID manager and in communication with the main link channels.

4. The video display controller of claim 1, wherein the video display controller is internal to a personal computer.

5. The video display controller of claim 4, further comprising a graphics processing unit in communication with the EDID manager.

6. The video display controller of claim 5, further comprising a transmit processor in communication with the graphics processing unit.

7. The video display controller of claim 6, further comprising a connector in communication with the transmit processor and adapted for communication with the display devices.

8. An information handling system comprising:
at least two DisplayPort-enabled display devices; and
a video display controller including a main link channel in communication with each of the display devices, and an Extended Display Identification Data (EDID) manager accepting EDID data from the display devices and controlling output to each of the display devices over a corresponding main link channel.

9. The information handling system of claim 8, wherein the video display controller is external to a personal computer.

10. The information handling system of claim 9, further comprising a lane splitter in communication with the EDID manager and in communication with the main link channels.

11. The information handling system of claim 8, wherein the video display controller is internal to a personal computer.

12. The information handling system of claim 11, further comprising a graphics processing unit in communication with the EDID manager.

13. The information handling system of claim 12, further comprising a transmit processor in communication with the graphics processing unit.

14. The information handling system of claim 13, further comprising a connector in communication with the transmit processor and adapted for communication with the display devices.

15. A method of controlling at least two DisplayPort-enabled display devices, the method comprising:
providing a main link channel in communication with each of the display devices; and
accepting Extended Display Identification Data (EDID) from the display devices and controlling output to each of the display devices over a corresponding main link channel.

16. The method of claim 15 further comprising providing a lane splitter in communication with the EDID manager and in communication with the main link channels.

17. The method of claim 16, further comprising providing a graphics processing unit in communication with the EDID manager.

18. The method of claim 17, further comprising providing a transmit processor in communication with the graphics processing unit.

19. The method of claim 18, further comprising providing a connector in communication with the transmit processor for communicating with the display devices.
